(19) United States
(12) Patent Application Publication
(10) Pub. No.: US 2026/0283106 A1
(43) Pub. Date: Sep. 24, 2026

(54) AUTOMATIC CAN FOOD FEEDER AND RELATED METHOD

(71) Applicant: Amletech Inc., San Diego, CA (US)

(72) Inventors: Jingcheng Zhuang, San Diego, CA (US); Qingjin Du, San Diego, CA (US)

(73) Assignee: Amletech Inc., San Diego, CA (US)

(21) Appl. No.: 19/676,055

(22) Filed: May 13, 2026

Related U.S. Application Data
(63) Continuation-in-part of application No. 19/260,283, filed on Jul. 4, 2025, now Pat. No. 12,686,524.
(60) Provisional application No. 63/679,091, filed on Aug. 3, 2024.

(51) Int. Cl. A01K 5/02

(52) U.S. Cl. CPC A01K 5/0287

(57) ABSTRACT

An automatic can food feeder includes a housing with a working area and a trash area containing a trash bin and a trash bin lid. The trash bin lid is designed to horizontally translate along tracks between a fully closed state and a fully opened state to provide access to the trash bin. A pivoting latch is rotatably coupled to the trash bin lid and includes first and second latch arms designed to engage a vertical post of a gripper. The pivoting latch incorporates a bistable mechanism, such as a compression spring, that ensures the latch remains in either an opening position or a closing position based on the threshold of force applied by the vertical post. Engagement between the post and the latch arms translates the lid until a limit is reached, causing the latch to flip states.

### CROSS-REFERENCE TO RELATED APPLICATIONS

This application claims benefit of priority with U.S. Provisional Application Ser. No. 63/679,091, filed Aug. 3, 2024; the entire contents of which are hereby incorporated by reference.

### BACKGROUND

### Field of the Invention

The present disclosure generally relates to automation devices, and more specifically it relates to the automatic can food feeders or dispenser, and it addresses and solves all limitations and drawbacks existing in prior arts. It covers a full system, which is ready for the final products as is or with some further optimizations.

### Description of the Related Art

Feeding cats canned food is a common practice among pet owners due to its nutritional benefits and palatability; however, the manual process of opening cans, scooping out the food, and cleaning up afterward can be messy and time-consuming. This routine must often be performed multiple times per day, requiring the owner's consistent presence and attention. As a result, it can be inconvenient for individuals with busy schedules and makes it difficult for owners to be away from home for extended periods without arranging for someone to feed their pet. Despite advances in automatic pet feeders for dry kibble, there remains a lack of effective automated solutions specifically designed to handle the unique challenges of storing, opening, serving, and disposing of canned cat food.

### SUMMARY

In an aspect of the present disclosure, an automatic can food feeder that mainly has a supply area to store bowls and cans, a working area to open the can and pour the food into a bowl, a serving or feeding area where the food can be consumed, as well as a trash area to hold the used bowls, left-over food and empty cans is presented.

In another aspect of the present disclosure, a method to store the cans and bowls and use a robotic gripper to grab bowls and cans, as well as a method to open the can by holding the can upside down and pulling the pull-ring downward so the food can be released to the bowl underneath are presented.

In yet another aspect of the present disclosure, a swivel-door based serving area, which can be used as serving area, temporary food keeping area as well as working area is presented.

In still another aspect of the present disclosure, a method to put the used bowels, left-over and empty cans to the trash area is presented.

In still another aspect of the present disclosure, a method to align the direction of the pull-ring so it can be properly pulled by the puller is presented. While the presented can opener assembly, which is able to align and pull pull-ring to open the can, this disclosure may also work with other various types of food cans by modifying or redesigning the can opener assembly.

Additional features, methods and advantages of this disclosure will be described in the following sections. The disclosure may be readily utilized as the basis for modifying or designing other similar products. It is to be expressly understood that the figures are provided for the purpose of illustration and description only and are not intended as a definition of the limits of the present disclosures.

### BRIEF DESCRIPTION OF THE DRAWINGS

Other features, combinations, and embodiments will be appreciated by one having the ordinary level of skill in the art upon a thorough review of the following details and descriptions, particularly when reviewed in conjunction with the drawings, wherein:

FIG. 1 shows an external appearance of a automatic wet can food feeder and its basic external parts;

FIG. 2 is a simplified front-view diagram of an interior of the automatic wet can food feeder;

FIG. 3 is a simplified illustration of an exemplary gripper design and the operations in accordance with aspects of the present disclosure;

FIG. 4 is a diagram illustrating an exemplary step in the can opening process in accordance with aspects of the present disclosure;

FIG. 5 is a diagram, looking upward to the can when it is hold by the gripper, illustrating the concept of pull-ring alignment in accordance with aspects of the present disclosure;

FIG. 6 shows an exemplary can opener assembly, which can be used as both a ring aligner and a puller;

FIG. 7 shows an exemplary driving chain for the can opener assembly;

FIG. 8A shows a rear view of the automatic can food feeder with the gripper and a translating trash bin lid in accordance with aspects of the present disclosure;

FIG. 8B shows the gripper and the translating trash bin lid in an alternate state; and

FIG. 8C shows yet the gripper and the translating trash bin lid in yet another alternate state;

FIG. 9A shows a rear perspective view of a trash bin lid in accordance with alternative embodiment;

FIG. 9B shows a bottom view of a latch of the trash bin lid according to the alternative embodiment;

FIG. 9C shows a rear perspective view of the trash bin lid positioned in the serving area according to the alternative embodiment;

FIG. 9D shows a rear perspective view of the trash bin lid positioned in the serving area with the latch in alternate state according to the alternative embodiment;

FIG. 9E shows a rear perspective view of vertical posts engaging with the latch of the trash bin lid to translate back over the trash bin according to the alternative embodiment;

FIG. 9F shows a rear perspective view of the trash bin lid repositioned over the trash bin according to the alternative embodiment;

FIG. 9G shows a bottom view of the latch of the trash bin lid with a spring according to the alternative embodiment;

FIG. 10A shows a rear view of the trash area in accordance with an alternative embodiment;

FIG. 10B shows a side view of the trash area according to the alternative embodiment;

FIG. 11A shows a perspective view of the serving area with bowl retention latches in accordance with an alternative embodiment;

FIG. 11B shows an alternate perspective view of the serving area with the bowl retention latches according to the alternative embodiment; and

FIG. 11C shows a perspective view of a latch driving mechanism of the bowl retention latches according to the alternative embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

The features, components, and configurations described in connection with the various embodiments illustrated herein may be combined, interchanged, or otherwise modified in any number of ways without departing from the scope and spirit of the invention. The embodiments are presented by way of example and not limitation, and it is intended that the invention encompasses all such combinations, permutations, and modifications as would be understood by those skilled in the art.

For purposes herein, the term “substantially” means within 15%.

The term “disposed above” means to be positioned directly over or at an offset of another object.

The term “translate between” means to move back and forth between two areas.

Unless explicitly defined herein, terms are to be construed in accordance with the plain and ordinary meaning as would be appreciated by one having skill in the art.

### General Description of Embodiments

In a general embodiment, an automatic can feeder machine is disclosed. The machine includes a housing comprising a plurality of areas, including a supply area configured to store a plurality of bowls and a plurality of cans, a serving area for providing exterior access to one of the bowls containing food from at least one of the cans, a trash area disposed adjacent to at least one of the supply area and the serving area, and a working area disposed above the trash area. The trash area comprises a trash bin and a trash bin lid, the lid being configured to horizontally translate between the trash area and the serving area. A can opener assembly is disposed at the working area and is configured to open each of the cans. The can opener assembly includes a puller configured to engage with a pull-ring of a can and rotate downwards toward the trash area, and an aligner configured to orient a can prior to opening. The puller and aligner each rotate about a stationary base. The aligner comprises an aligner table and an aligner arm, where the table supports the can and rotates about a vertical axis, and the arm pushes the pull-ring to a predetermined direction by its own rotation. The can opener assembly comprises an aligner mode, in which the aligner table is substantially horizontal and the puller is below the table to allow the can to be oriented, and a puller mode, in which the aligner table is substantially vertical and the puller is above the table to engage and rotate the can downward. A single motor actuates both the puller and the aligner. A gripper is configured to move horizontally and vertically within each of the areas, and simultaneously transport a bowl and at least one can from the supply area to the working area. The gripper includes a gripper body and a plurality of gripper fingers rotatably coupled to the gripper base. Each finger includes a hook portion and an elongated portion, with a rotation axis between the two. The gripper is configurable into a bowl-grabbing configuration, where the hook portion is below the gripper body and the elongated portion is above, and a can-grabbing configuration, where the elongated portion is below the body and the hook portion is above. A vertical post enables the gripper's vertical movement and is configured to engage with the trash bin lid to translate it between the trash area and the serving area.

In some embodiments, the can opener assembly may comprise an angle limiter providing a rotation limit to the puller, such that upon a forward rotation beyond the limit, the assembly may convert from the puller mode to the aligner mode.

In some embodiments, the puller may comprise a reverse rotation opposite the forward rotation, such that upon the reverse rotation, the can opener assembly may convert from the aligner mode to the puller mode.

In some embodiments, the aligner may be slidable to adjust for various sized cans.

In some embodiments, the trash bin lid may comprise an actuating member configured to alternate between a static state and a dynamic state. During the dynamic state, the actuating member may engage with the vertical post so that horizontal movement of the gripper applies a horizontal force to the actuating member, thereby translating the lid.

In some embodiments, the trash bin lid may be configured to block the trash area from the working area, supply area, and trash area. Upon translation into the serving area, the lid may block the serving area from the working area and the trash area.

In some embodiments, the supply area may comprise the bowls and cans such that at least one can is disposed between each adjacent pair of bowls.

In some embodiments, each of the cans may be positioned upside down within the supply area.

In some embodiments, the serving area may comprise a swivel door configured to rotate about a vertical axis.

In some embodiments, the swivel door may comprise an open state and a closed state, where the open state allows access to the serving area from outside the housing, and the closed state prevents such access.

In some embodiments, the trash area may be disposed between the supply area and the serving area.

In some embodiments, the gripper may be further configured to transport the bowl from the working area to the serving area and from the serving area to the trash area.

In another general embodiment, an automatic can feeder machine is disclosed. The machine includes a housing comprising a supply area to store a plurality of bowls and cans, a serving area for providing exterior access to a bowl containing food from at least one can, a trash area adjacent to the supply and/or serving area including a trash bin and lid, and a working area above the trash area. A can opener assembly is disposed in the working area and includes a puller configured to engage with a pull-ring of a can and rotate downward toward the trash area. A gripper is configured to move horizontally and vertically within each area and to simultaneously transport a bowl and at least one can from the supply area to the working area.

In some embodiments, the can opener assembly may further comprise an aligner configured to orient a can before opening. The aligner may include an aligner table to support the can and rotate about a vertical axis, and an aligner arm to push the pull-ring in a predetermined direction by rotation.

In some embodiments, the can opener assembly may include an aligner mode where the aligner table is substantially horizontal and the puller is below the table, such that the can is rotated and oriented by the aligner arm.

In some embodiments, the can opener assembly may further include a puller mode in which the aligner table is substantially vertical and the puller is above the table, such that the puller may engage the can and rotate it downward toward the trash area.

In some embodiments, the can opener assembly may include an angle limiter to restrict puller rotation, wherein upon a forward rotation beyond the limit, the assembly may convert from puller mode to aligner mode.

In some embodiments, the puller may allow reverse rotation, such that upon reverse rotation the assembly may convert from aligner mode to puller mode.

In some embodiments, the can opener assembly may include a single motor configured to actuate both the puller and the aligner.

In some embodiments, the can opener assembly may include a stationary base, about which the puller and aligner may rotate.

In some embodiments, the aligner may be slidable to adjust for cans of various sizes.

In some embodiments, the gripper may comprise a gripper body and a plurality of gripper fingers rotatably coupled to the gripper base.

In some embodiments, each of the gripper fingers may comprise a hook portion and an elongated portion, with the axis of rotation disposed between the hook portion and the elongated portion.

In some embodiments, the gripper may be configurable into a bowl-grabbing configuration and a can-grabbing configuration. The bowl-grabbing configuration may place the hook portion below the gripper body and the elongated portion above it, while the can-grabbing configuration may place the elongated portion below the body and the hook portion above it.

In some embodiments, the trash bin lid may be configured to horizontally translate between the trash area and the serving area.

In some embodiments, the gripper may comprise a vertical post for vertical movement, and the vertical post may engage the trash bin lid to translate it between the trash area and serving area.

In some embodiments, the trash bin lid may comprise an actuating member that alternates between static and dynamic states. During the dynamic state, the actuating member may engage the vertical post, and the post may apply horizontal force to translate the lid.

In some embodiments, the trash bin lid may be configured to block the trash area from the working area, supply area, and trash area. Upon translation into the serving area, it may block the serving area from the working and trash areas.

In some embodiments, the supply area may contain bowls and cans, with at least one can disposed between each adjacent pair of bowls.

In some embodiments, the cans may be positioned upside down in the supply area.

In some embodiments, the serving area may include a swivel door configured to rotate about a vertical axis.

In some embodiments, the swivel door may include an open state and a closed state, with the open state allowing exterior access to the serving area and the closed state preventing such access.

In some embodiments, the trash area may be disposed between the supply area and the serving area.

In some embodiments, the gripper may be configured to move the bowl from the working area to the serving area, and from the serving area to the trash area.

In one general aspect, a method for serving food from a can is disclosed. The method includes transporting a bowl and a can by a gripper from a supply area to a working area, where the working area is above a trash area such that the bowl and can are placed on a trash bin lid. The method further includes separating the can from the bowl using the gripper, moving the can to a can opener assembly in an inverted state, aligning the can by rotation using the can opener, and opening the can above the bowl so food falls into the bowl. The method also includes translating the trash bin lid into a serving area to expose the trash bin, releasing the can into the bin, translating the lid back to cover the bin, and moving the bowl holding the food from the working area to the serving area using the gripper.

In some aspects, transporting the bowl and the can may comprise the gripper moving vertically into the supply area.

In some aspects, separating the can from the bowl may comprise rotating a plurality of gripper fingers from a bowl-grabbing configuration to a can-grabbing configuration.

In some aspects, each gripper finger may comprise a hook portion, an elongated portion, and an axis of rotation between them, and each may rotate about a gripper body.

In some aspects, the bowl-grabbing configuration may place the hook portion below the gripper body and the elongated portion above, and the can-grabbing configuration may place the elongated portion below the body and the hook portion above.

In some aspects, translating the trash bin lid into the serving area and trash area may be caused by horizontal movement of the gripper.

In some aspects, the method may further comprise opening a door of the serving area to allow exterior access.

In some aspects, transporting the bowl and the can may further comprise simultaneously transporting both items by the gripper.

In some aspects, the method may further comprise moving the bowl from the serving area to the trash area by the gripper.

In a general embodiment, an automatic can feeder system is disclosed. The system includes a housing comprising a trash area disposed between a supply area and a serving area, and a working area disposed above the trash area. A trash bin is located in the trash area, and the trash bin includes a trash bin lid configured to horizontally translate along a track between a closed state and an opened state. One or more vertical posts are configured to move horizontally within the housing from the supply area to the serving area. An engagement member is rotatably coupled to the trash bin lid and is configured to engage with and receive a horizontal force from the one or more vertical posts. Horizontal translation of the one or more vertical posts results in the trash bin lid translating horizontally along the tracks.

In some embodiments, the one or more vertical posts may be configured to move the trash bin lid from the opened state to the closed state.

In some embodiments, the one or more vertical posts may be configured to move the trash bin lid from the closed state to the opened state.

In some embodiments, the engagement member may be rotatably configurable in a plurality of positions. A first position of the plurality of positions may comprise engagement with the one or more vertical posts, and a second position of the plurality of positions may comprise disengagement from the one or more vertical posts.

In some embodiments, the trash bin lid may be configured to translate into the serving area.

In some embodiments, the engagement member may further comprise a pivoting latch rotatably coupled to the trash bin lid about a center axis.

In some embodiments, the pivoting latch may further comprise a first latch arm and a second latch arm. The first latch arm and the second latch arm may each be configured to extend outward from an outer edge of the trash bin lid.

In some embodiments, the one or more vertical posts may be configured to engage with one of the first latch arm or the second latch arm to move the trash bin lid into one of the opened state or the closed state.

In some embodiments, the pivoting latch may be configured to rotate between an opening position and a closing position. While in the opening position, the pivoting latch may be configured to engage with the one or more vertical posts to move the trash bin lid from the closed state into the opened state. While in the closing position, the pivoting latch may be configured to engage with the one or more vertical posts to move the trash bin from the opened state to the closed state.

In some embodiments, the pivoting latch may further comprise a bistable mechanism to provide stability to the pivoting latch in both the opening position and the closing position.

In some embodiments, the bistable mechanism may comprise a compression spring coupled to the trash bin lid at a fixed first anchor point and to the pivoting latch at a dynamic second anchor point.

In some embodiments, the first anchor point and the second anchor point may be configured to collinearly align with the center axis of the pivoting latch such that the spring reaches a state of greatest elastic potential energy when the second anchor point is positioned between the center axis and the first anchor point.

In some embodiments, the bistable mechanism may be configured to move the pivoting latch towards one of the opening position or the closing position in response to a threshold force applied by the one or more vertical posts against one of the first latch arm or the second latch arm.

In some embodiments, the opening position of the pivoting latch may comprise the first latch arm extended further outward from the outer edge than the second latch arm.

In some embodiments, the closing position may comprise the second latch arm extended further outward from the outer edge than the first latch arm.

In some embodiments, the pivoting latch may be in the opening position when the trash bin lid is fully in the closed state.

In some embodiments, the pivoting latch may be in the closing position when the trash bin is fully in the opened state.

In another general embodiment, an automatic can feeder system is disclosed. The system includes a housing comprising a trash area disposed between a supply area and a serving area, and a working area disposed above the trash area. A trash bin is located in the trash area, and the trash bin includes a trash bin lid configured to horizontally translate along a track between a closed state and an opened state. One or more vertical posts are configured to move horizontally within the housing from the supply area to the serving area. An engagement member includes a pivoting latch rotatably coupled to the trash bin lid about a center axis. The engagement member is configured to engage with and receive a horizontal force from the one or more vertical posts. The engagement member is rotatably configurable in a plurality of positions, where a first position of the plurality of positions comprises engagement with the one or more vertical posts, and a second position of the plurality of positions comprises disengagement from the one or more vertical posts. Horizontal translation of the one or more vertical posts results in the trash bin lid translating horizontally along the tracks. Further, the one or more vertical posts are configured to move the trash bin lid from the opened state to the closed state and from the closed state to the opened state.

In some embodiments, the pivoting latch may further comprise a first latch arm and a second latch arm. The first latch arm and the second latch arm may each be configured to extend outward from an outer edge of the trash bin lid.

In some embodiments, the one or more vertical posts may be configured to engage with one of the first latch arm or the second latch arm to move the trash bin lid into one of the opened state or the closed state.

In some embodiments, the pivoting latch may be configured to rotate between an opening position and a closing position. While in the opening position, the pivoting latch may be configured to engage with the one or more vertical posts to move the trash bin lid from the closed state into the opened state. While in the closing position, the pivoting latch may be configured to engage with the one or more vertical posts to move the trash bin from the opened state to the closed state.

In some embodiments, the pivoting latch may further comprise a bistable mechanism to provide stability to the pivoting latch in both the opening position and the closing position.

In some embodiments, the bistable mechanism may comprise a compression spring coupled to the trash bin lid at a fixed first anchor point and to the pivoting latch at a dynamic second anchor point.

In some embodiments, the first anchor point and the second anchor point may be configured to collinearly align with the center axis of the pivoting latch such that the spring reaches a state of greatest elastic potential energy when the second anchor point is positioned between the center axis and the first anchor point.

In some embodiments, the bistable mechanism may be configured to move the pivoting latch towards one of the opening position or the closing position in response to a threshold force applied by the one or more vertical posts against one of the first latch arm or the second latch arm.

In some embodiments, the opening position of the pivoting latch may comprise the first latch arm extended further outward from the outer edge than the second latch arm.

In some embodiments, the closing position may comprise the second latch arm extended further outward from the outer edge than the first latch arm.

In some embodiments, the pivoting latch may be in the opening position when the trash bin lid is fully in the closed state.

In some embodiments, the pivoting latch may be in the closing position when the trash bin is fully in the opened state.

Each of the components of the can food feeder and related subsystems described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

Aspects of the present disclosure are directed to an implementation of an automatic can food feeder system that mainly features grabbing a new bowl and a new can, opening the can and pouring the food into the bowl in working area, putting the empty can to the trash area, and sending the bowl with food to the serving area on preset or adaptive schedule.

### Illustrated Embodiments

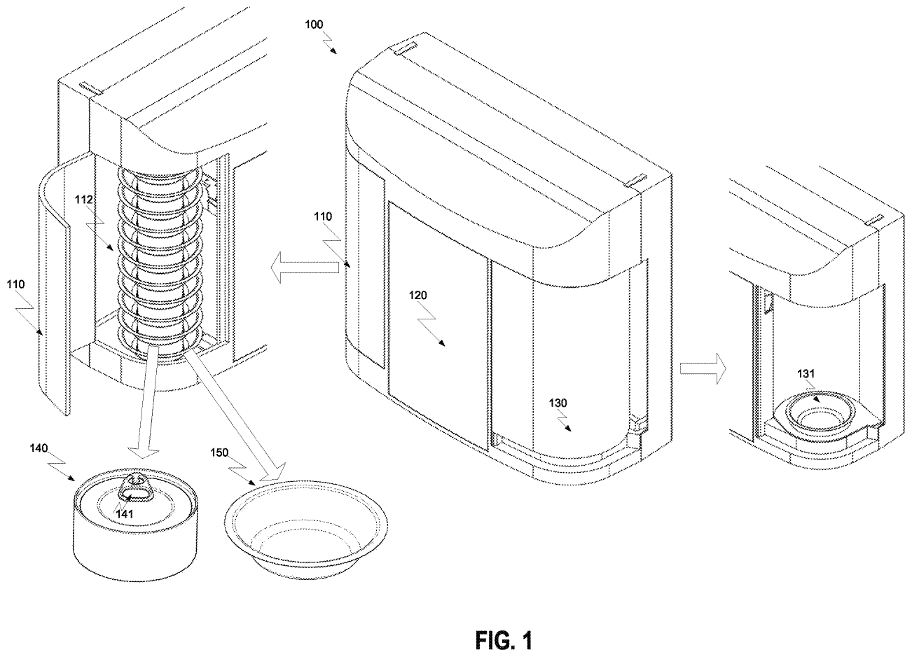

FIG. 1 shows a possible external appearance of a wet can food feeder based on this disclosure. The pull-ring cans (such as 140) are widely used nowadays for wet pet foods. This type of can is designed to be easily opened by pulling the pull-ring 141 while holding the can, however the procedure is usually done manually. Once the can is opened, the food is then poured into the bowl. After the food is consumed, the bowl with left-over needs to be discarded. This procedure is usually repeated regularly and requires a lot of human's attention and efforts. With this invention, the full procedure can be done automatically on a predefined or adaptive schedule.

The full machine 100 comprises a plurality of area including a supply area covered by an access door 110. The supply area is to store all unused bowls (such as 150) and cans (such as 140) by stacking them as illustrated as 112. To facilitate the operation, each can is placed upside-down (so the pull-ring is faced down) in the bowl.

The door 120 is to access a trash area having a trash bin, which holds used bowls, left-over food and empty cans. The swivel door 130 to the serving area may rotate along a vertical axis to open and to close. When the serving area is opened, the bowl 131 with food may be consumed by the pets from the right-front corner of the machine.

The serving area may be closed for temporarily preserving the food so the pets may only eat the food based on certain schedule, and it may also be closed during the time when the bowl with leftover is replaced with a new one. Based on users'preference, the bowl may be reused or replaced by a new bowl from the supply chamber.

The serving area with the swivel door 130 has many advantages. For example, when it is opened, the cylinder wall is able to separate an inner chamber of the machine from the external part where the pets consume food with a better decorating effect. When it is closed, the food can be kept inaccessible from the pets, thus the serving area is converted to the internal part of the machine so the used bowl may be grabbed by a robotic gripper, and the new food could be prepared and placed down to the bottom of the serving area and so on. Once the serving area is closed, the gripper and all internal operations are isolated from external disturbances for the safety of the pets when the machine is operating.

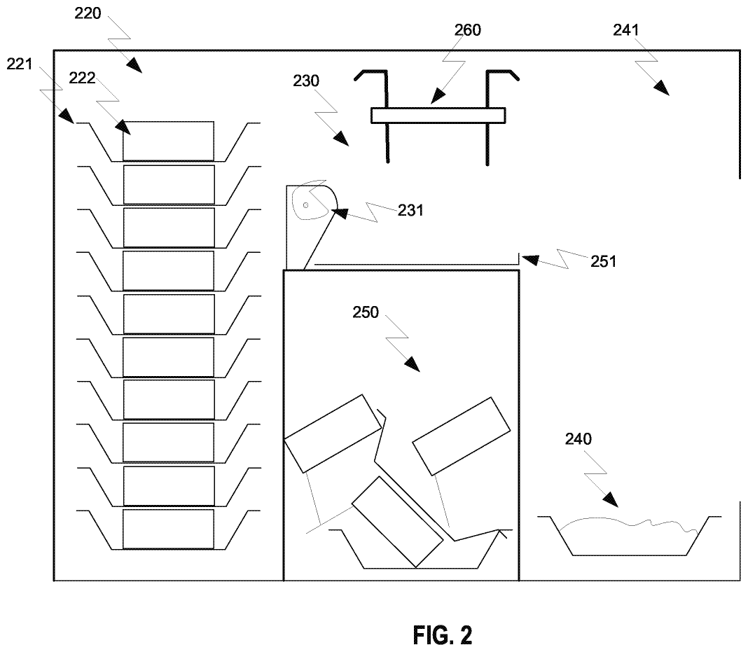

FIG. 2 is a simplified high level diagram of the internal view illustrating a possible design of the present disclosure. The exemplary system has the following main areas (or function blocks): a supply area 220 (corresponding to 112 in FIG. 1), a working area 230, a serving area 240 (corresponding to 130 or 131 in FIG. 1), and a trash area 250. In the supply area 220, one or more bowls 221 and one or more cans 222 are stored. One aspect of this disclosure includes a way to store bowls and cans by stacking them together alternatively as illustrated in the figure. So the bowls with a can inside each may be used to prepare the can food more conveniently and efficiently. It is also possible to have different combinations of cans and bowls in the supply area. For example, multiple cans may be corresponding to one single bowl if customers prefer to reuse the bowl for multiple cans.

In the working area 230, the can opener assembly 231 is presented. The can could be opened in or around this area, and the food is poured into a bowl. Then the bowl with food inside is carried to the serving area 240, where the bowl with the food is placed and ready to be consumed. The used bowls, cans, as well as the left-over food are placed into the trash area 250 comprising a trash bin and trash bin lid 251.

A gripper 260, designed to grab cans and bowls (more details are presented later), is able to move horizontally and vertically to perform multiple functions. For example, it can grab new bowls and cans. It also assists in the can opening procedure by holding the can when the pull-ring is pulled by a puller, pouring food from the opened cans into the bowls and moving the bowls with food into the serving area. It can also grab used bowls with leftover and put them into trash area 250 and so on. The mechanism to move the gripper horizontally and vertically is not shown in the figure but one having skill in the art can appreciate a myriad of ways to achieve movement of the gripper. For example, it can be implemented using two dimensional linear motors or other equivalent methods.

The exemplary system is able to perform the following different functions but not limited to: 1. Temporarily move the food away from the serving area, and then place back to the serving area sometime later, or simply close and then reopen the swivel door on predefined feed schedule (130 in FIG. 1); 2. Move the used bowl with left-over into the trash area 250; 3. Prepare a new bowl of food and place them to the serving area 240; 4. Combine the above functions 2 and 3.

Mode 4 operation is described here to illustrate the advantages of the concepts presented in this disclosure. After the swivel door in the serving area (130 in FIG. 1) is closed, the gripper 260 moves down to the serving area to grab the used bowl, and then moves up into the proximity of 241, meanwhile the trash bin lid 251 slides to the right to open the trash bin from the top. The gripper 260 then drops the used bowl into the trash bin, and after that, the lid 251 of the trash bin could slide back to close the trash bin.

The gripper 260 then moves to the supply area 220 to grab a pair of bowl and can and carries both to the top of the trash bin lid 251, which is also used as a working table to prepare the food. On the trash bin lid, the gripper further grabs the can from the same bowl, and takes it to the can opener assembly 231, where the can is opened (more details are presented later) and food is poured into the bowl underneath.

The trash bin lid 251 is then translates horizontally to the right to open the trash bin so the emptied can is dropped into the trash area 250. As the trash bin is directly underneath the working area 230 where the can is opened, no excessive food is left anywhere except for the trash bin. The bowl with the food inside, which is on top of the trash bin lid 251 of the trash bin, is then grabbed and moved to the serving area 240, while the trash bin lid 251 is slid to the left to fully close the trash bin.

After the new bowl of food is placed in the serving area, the swivel serving door rotates to the open position so the food is ready to be consumed.

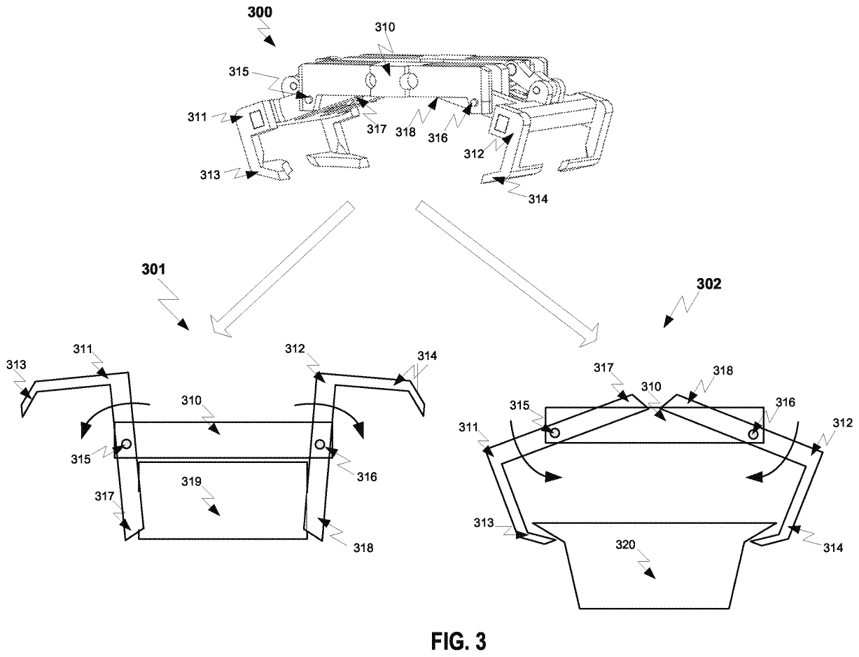

FIG. 3 shows the operation principle of an exemplary gripper 300. In this figure, 300 is the 3-D drawing of the gripper; 301 shows the gripper in a can-grabbing configuration to hold a can while 302 shows the gripper in a bowl-grabbing configuration to hold a bowl. The gripper fingers 311 and 312 are attached to a gripper base 310 and can rotate along the axis of 315 and 316 to grab cans and bowls respectively.

To grab a can, fingers 311 and 312 firstly rotate so that hook portion 313 and 314 ar on the top of the gripper body 310 while elongated portion 317 and 318 point downward. With the can 319 underneath of the body 310 and between 317 and 318, the fingers then rotate in the direction as shown in 301 so that 317 and 318 can grab the side walls of the can as illustrated in the figure.

Similarly, in the position of the bowl-grabbing configuration 302, the same gripper 300 may be used to grab a bowl. Fingers 311 and 312 rotate in the direction as shown in the figure so the hook portions 313 and 314 are able to grab the bowl 320 underneath. The gripper design concept illustrated in FIG. 3 has significant advantages when used in this automatic can food feeder. It has a compact size and is able to grab both bowls and cans firmly. In addition, the elongated portions 317 and 318 of the fingers are able to reach inside of a bowl to pick up the can, allowing the cans to be placed and stored in the bowls in the supply chamber.

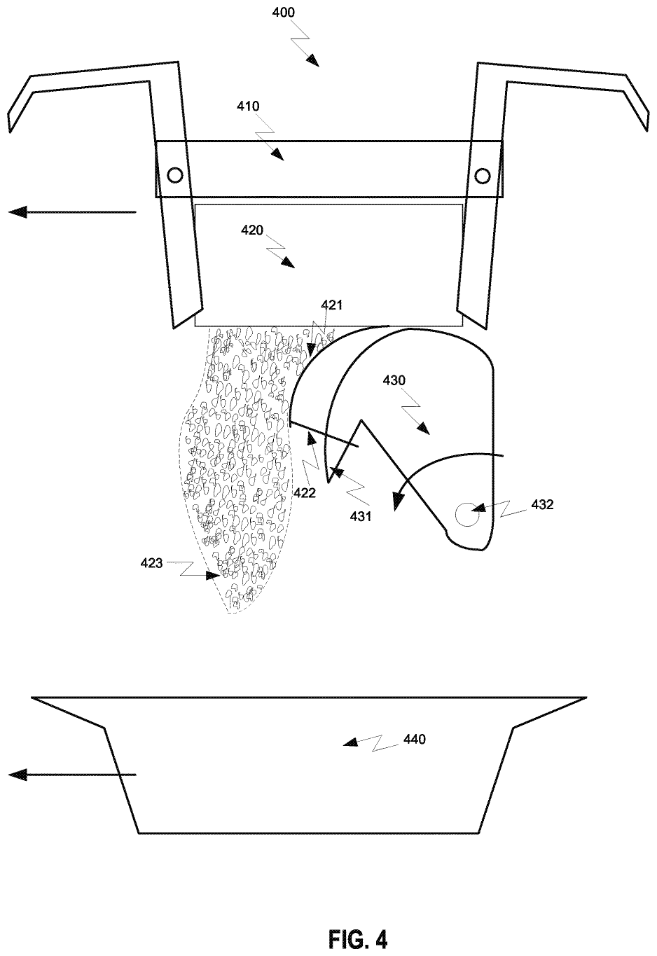

FIG. 4 is a diagram illustrating an exemplary step during the can opening process in accordance with aspects of the present disclosure. The gripper 410 holds a can with its ring/lid facing downward and places the can on top of the puller 430. The sharp end 431 of the puller is able to grab the pull-ring 422 of the can 420 so the lid 421 of the can 420 is pulled to open by rotating the puller 430 along the axis 432, while the gripper may move horizontally or vertically accordingly to fully open the can. After the lid 421 is pulled wide enough, the food 423 may fall into the bowl 440 underneath gradually. In one possible implementation, the bowl and gripper may move horizontally in a synchronized fashion to the left so that the lid is fully opened and food may drop down to the bowl.

In the actual implementation, the can with the lid and pull-ring facing down is not necessarily straight downward. It can be also tilted to a certain angle for the best performance. For example, the cans can also be opened sideway, i.e. the lid faces to the left or to the right, assuming the gripper may rotate accordingly. They can be also opened by tilting to other angles using the same concepts and methods. This may bring one advantage that the food liquid in the cans can be avoided from dropping to the puller during the time when the pull-ring is pulled open.

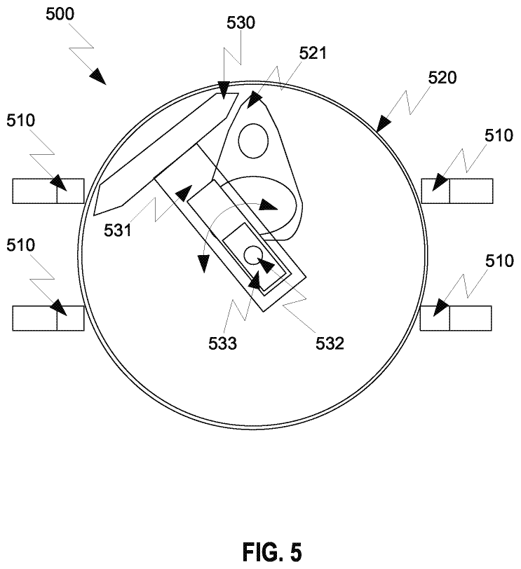

To improve user experience and minimize the user's effort, certain aspects of this disclosure allow the cans to be placed inside the bowls with the lids facing downward in the supply area with the pull-ring pointing to any random direction. Before the puller is able to hold the pull-ring to open the can, the pull-ring must be aligned or rotated to a known direction (align with the direction of the puller). This is done by using the pull-ring alignment mechanism which is illustrated in FIG. 5. The gripper fingers 510 hold the can lightly to allow the can 520 to spin along the axle 532. Regardless of the initial pull-ring direction, the aligner 530 is able to rotate along the axle 532 to a known angle or direction, so that the pull-ring 521 is pushed into the predetermined direction (matched with the puller 431 in FIG. 4). The aligner 530 shown in the figure may rotate two directions, and it can also be designed to do one way rotation. After the pull-ring 521 is rotated to an expected direction, the gripper increases the grabbing force to firmly hold the can and move it to the puller, where the can is opened as illustrated in FIG. 4 which is described previously.

When adjuster 533 is rotated along the fixed axles 532, the body of the aligner 531 together with aligner 530, is also able to slide toward or away from the center of axle 532, thus the same mechanism is able to work for cans with different radius. Such an aligner may be integrated as the part of the can opener assembly 231, so the can opener assembly has both features of the aligner and puller. They can also be driven by the same electric motor or servo, to save the overall cost and to reduce the complexity (more details are given later).

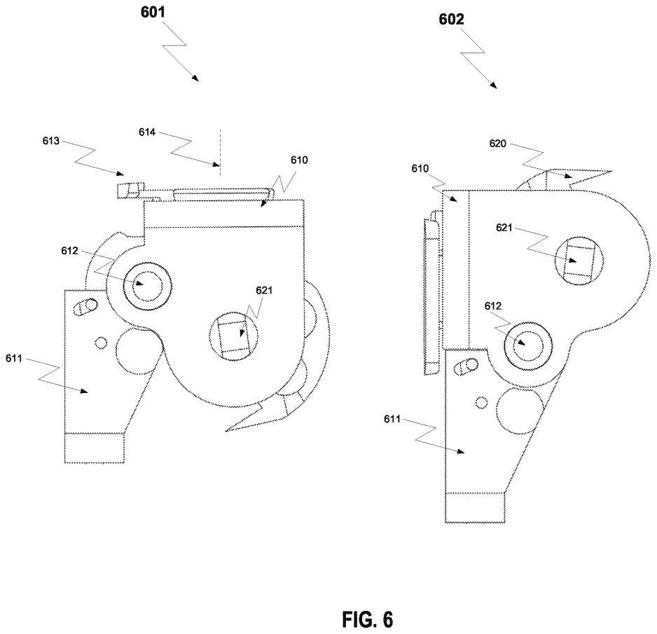

FIG. 6 is the side view of the exemplary can opener assembly in two different operation modes with two different positions: 601 is the aligner mode when the assembly is used as an aligner, and the aligner table 610 is rotated or folded to horizontal position along the axle of 612 on the stationery base 611. After the aligner table is in horizontal position, the aligner arm 613 pushes the pull-ring of the food can (placed on top of the aligner, not shown in the figure) to a predetermined direction by rotating along the vertical axel 614. In the same figure, drawing 602 shows the puller mode when the assembly is used as a puller with the aligner table 610 in vertical position. In this function mode, the puller tip 620 holds the pull-ring of the can, and rotates along the axle of 621 clock wise in a certain speed to gradually tear open the lid of the can (not shown in the figure) which is placed on top of the assembly.

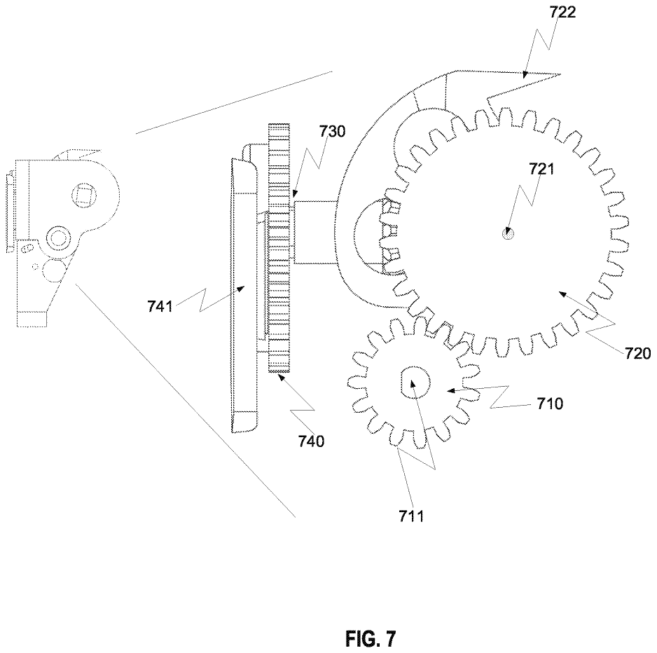

One of the advantages of the proposed opener assembly described above is that all related functions, such as folding up and down the aligner table (610 in FIG. 6), rotating the aligner (613 in FIG. 6), rotating the puller, can be driven with one single motor or servo. FIG. 7 illustrates one possible implementation of the driving chain for the opener assembly. In this figure, the main drive gear 710 is driven with a motor or servo so it spins along the axle 711 (corresponding to 612 in FIG. 6). Puller gear 720 together with the puller 722, rotating along axle 721 (corresponding to 621 in FIG. 6), is driven by the drive gear 710. While the aligner gear 740, together with the aligner 741 is also driven from the rotation of puller gear 720 through 730 using a bevel gears (not shown in the figure). Consequently, rotating drive gear 710 by the motor or servo is able to rotate both puller 722 and the aligner 741.

To be able to fold down the aligner table 741 (610 in FIG. 6), an angle limiter is added to the puller gear 720, so that the puller gear can only rotate within a certain range of angles which is required to open the can and to align the pull-ring. Once the limit is reached, the gear 720 stops rotating, and further rotating the drive gear 710 clock wise driven by the motor or servo would fold down the aligner table and the puller to a horizontal position, so the aligner position is obtained as shown in 601 of FIG. 6. Similarly, the aligner can be unfolded to the puller position (602 in FIG. 6) by rotating the drive gear 710 counter-clock wise beyond the angle limit in the opposite direction.

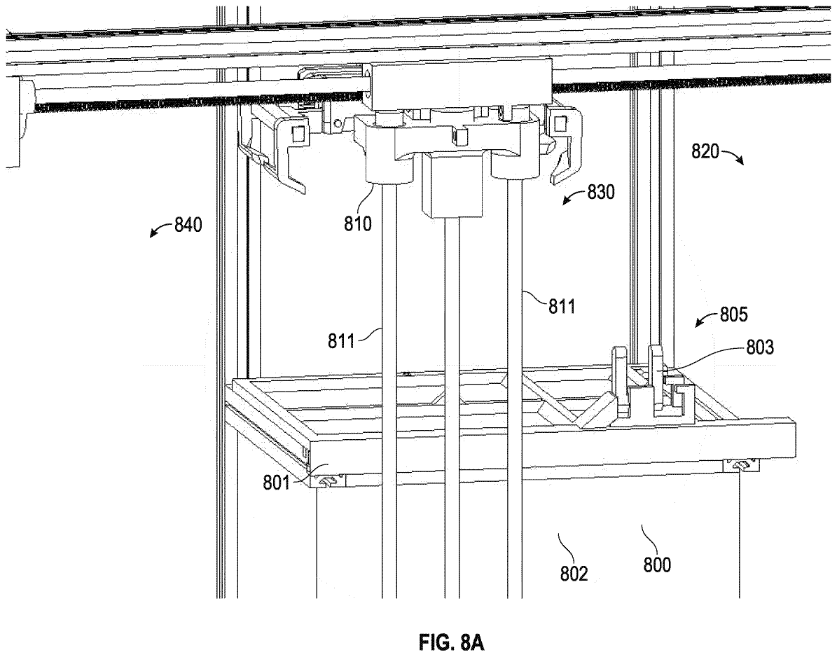

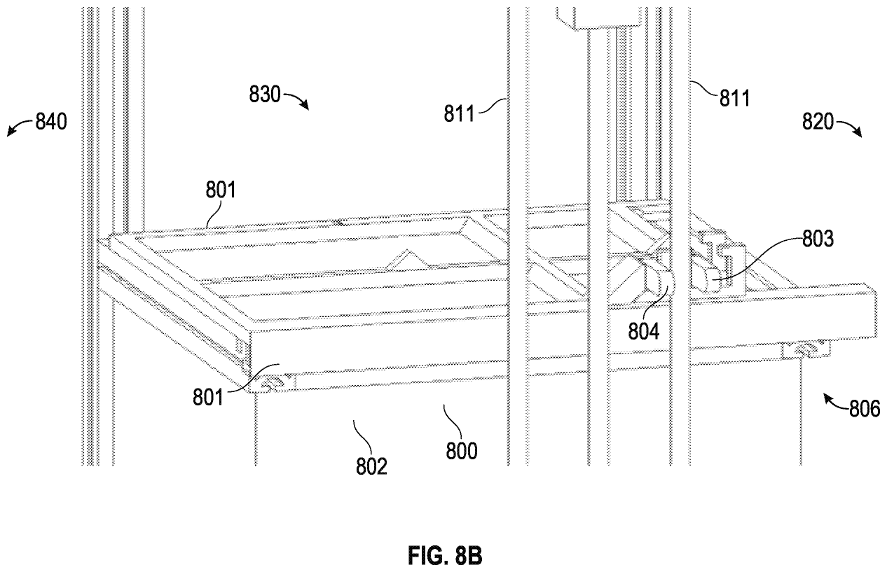

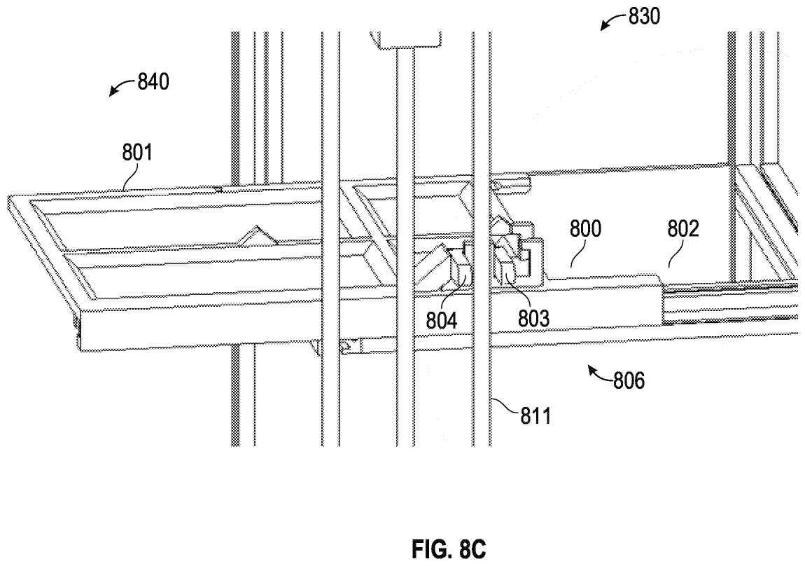

FIG. 8A-8C shows an interaction between the gripper 810 and the trash bin lid 801 of the trash area 800 according to an embodiment. The gripper 810 comprises vertical posts 811 to provide vertical movement of the gripper. As the gripper 810 translates horizontally from one area to another, the vertical posts 811 move in unison with said gripper 810. While in an idle state, the trash bin lid 801 covers a corresponding trash bin 802 within the trash area 800 and blocks the trash area from each of the other areas, namely the supply area 820, the working area 830, and the serving area 840. The trash bin lid 801 is further configured to translate horizontally from the trash area 800 into the serving area 840. The horizontal translation is achieved by the vertical post 811 of the gripper 810 engaging with the trash bin lid 801 such that horizontal translation of the gripper 810 results in horizontal translation of the trash bin lid 801. The trash bin lid 801 is engaged with the trash bin 802 via tracks that guide the horizontal translation.

To control when the trash bin lid 801 does and does not move, the trash bin lid 801 may further comprise an actuating member 803 which is configured to engage and disengage from the vertical post 811. The actuating member 803 may comprise a rotating element 804 such that while in a vertical configuration the actuating member 803 is disengaged from the vertical post 811 to achieve a static state 805, and while in a horizontal configuration the actuating member 803 is engaged with the vertical post 811 to achieve a dynamic state 806. The actuating member 803 may engage with the vertical post 811 by other means as can be appreciated by one having skill in the art. For example, the actuating member may comprise linear translation with forward translation resulting in the dynamic state and backward translation resulting in the static state. The trash bin lid 801 can be configured to fully translate into the serving area 840 such that the trash bin lid 801 blocks the serving area 840 from the working area 830 and the trash area 800.

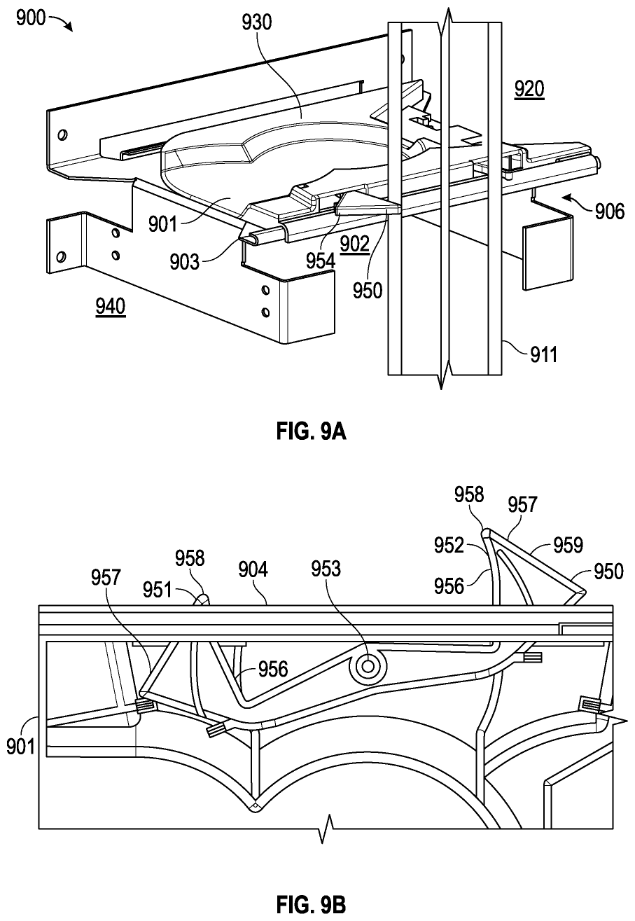

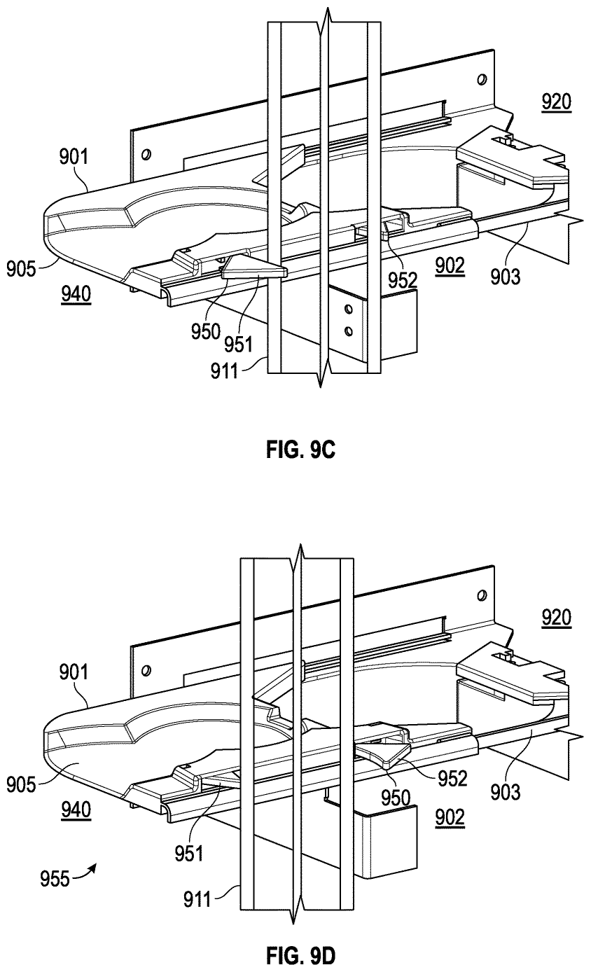

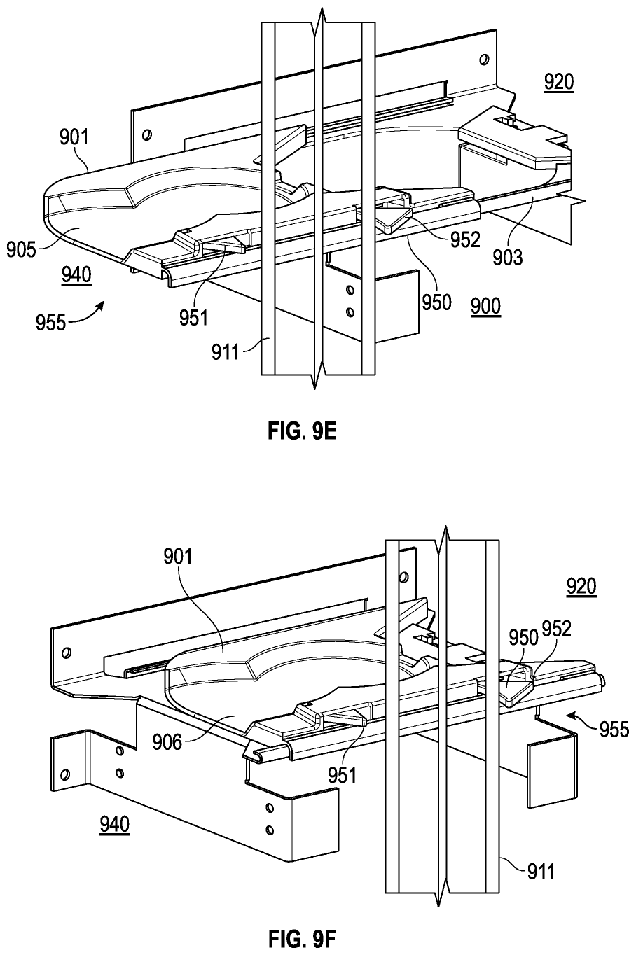

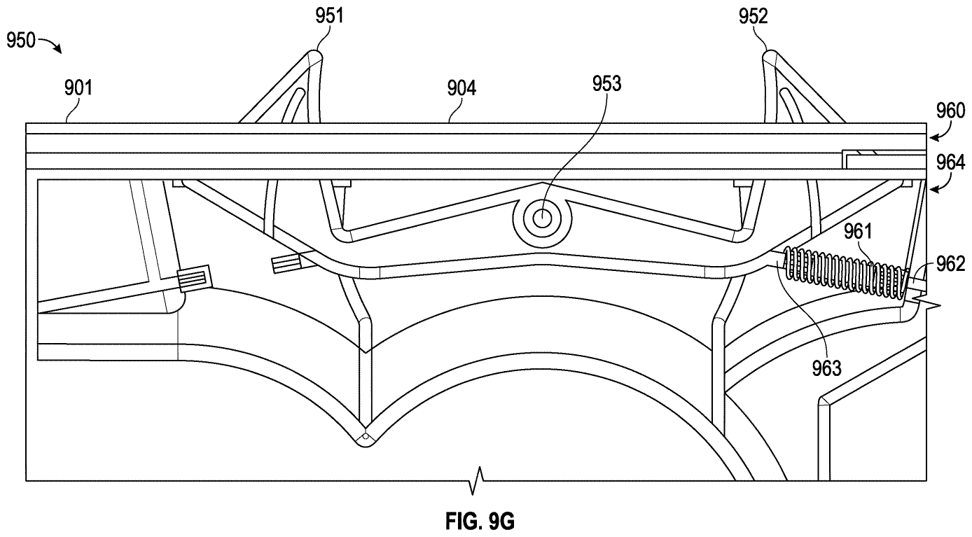

FIG. 9A-9G show the automatic can food feeder according to an alternative embodiment. This embodiment utilizes an alternative system and method for opening and closing a trash bin lid 901 within a trash area 900. The trash bin lid 901 is configured to horizontally translate along tracks 903 within a defined range between an open limit and a closed limit. At the open limit, the trash bin lid 901 is in a fully opened state 905, and at the closed limit, the trash bin lid 901 is in a fully closed state 906. These limits are achieved through the use of physical constraints such as stoppers, switches, sensors, or plungers configured to arrest the motion of the lid 901. The trash bin lid 901 utilizes a simple sliding interface to translate along the tracks 903.

The trash bin lid 901 comprises a pivoting latch 950 rotatably coupled to the trash bin lid 901 and configured to oscillate about a center axis 953. The pivoting latch 950, including its center axis 953 and portions of a first latch arm 951 and a second latch arm 952, is disposed under the trash bin lid 901. This underside positioning can help to avoid interference with the working area 930 located above. At least one of the first latch arm 951 or the second latch arm 952 is configured to at least partially extend outward from an outer edge 904 of the trash bin lid 901. Each arm 951, 952 is configured to engage with the vertical posts 911 of a gripper at different times, causing the pivoting latch 950 and the coupled trash bin lid 901 to horizontally translate in unison with the vertical posts 911.

In the fully closed state 906, the pivoting latch 950 is characterized as being in an opening position 954. In the opening position 954, the first latch arm 951 is substantially extended outward from the outer edge 904 of the trash bin lid 901 while the second latch arm 952 is substantially retracted. As the vertical posts 911 translate horizontally across the trash area 900 toward the serving area 940, they engage the extended first latch arm 951. Continued horizontal translation of the vertical posts 911 while engaged with the first latch arm 951 applies a force that causes the trash bin lid 901 to translate along the tracks 903 toward the serving area 940, thereby providing access to the trash bin 902.

Once the trash bin lid 901 reaches the open limit and enters the fully opened state 905, it is unable to translate further toward the serving area 940. Continued force applied by the translating vertical posts 911 against the first latch arm 951 causes the pivoting latch 950 to rotate about the center axis 953. This rotation retracts the first latch arm 951 into the trash bin lid 901 and conversely extends the second latch arm 952 outward from the lid 901. Following this retraction and extension, the pivoting latch 950 is characterized as being in a closing position 955. The vertical posts 911 may then translate back toward the trash area 900 to engage the now-extended second latch arm 952. This engagement causes the pivoting latch 950 and trash bin lid 901 to translate back into the trash area 900 to the fully closed state 906. Further translation of the vertical posts 911 toward a supply area 920 once the lid 901 is closed causes the second latch arm 952 to retract and the first latch arm 951 to extend, returning the latch 950 to the opening position 954.

Each of the first latch arm 951 and the second latch arm 952 comprises an inner portion 956 and an outer portion 957 tapering towards a latch apex 958. The inner portion 956 of the first latch arm 951 is configured to engage with the vertical posts 911 for opening the trash bin lid 901, and the inner portion 956 of the second latch arm 952 is configured to engage with the vertical posts 911 for closing the trash bin lid 901. The outer portion 957 of the first latch arm 951 and the second latch arm 952 form an acute angle 959 with the outer edge 904 while in the opening position 954 and the closing position, respectively. The acute angle 959 of the outer potion 957 allows for the vertical posts 911 to engage with and slide along the outer portion 957 when the pivoting latch 950 is an improper position to rotate the pivoting latch 950 such that the vertical posts 911 can then properly engage with the respective inner portion 956. Examples of an improper position of the pivoting latch 950 can include when the pivoting latch 950 is in the opening position 954 while the vertical posts 911 is disposed in the serving area 940 outside the outer portion 957 of the first latch arm 951, as well as when the pivoting latch 950 is in the closing position 955 while the vertical posts 911 is disposed in the supply area 920 outside the outer portion 957 of the second latch arm 952.

To ensure the pivoting latch 950 possesses sufficient stability to both horizontally translate and rotate upon the application of threshold force, the pivoting latch 950 comprises a bistable mechanism 960. In one embodiment, the bistable mechanism 960 comprises a compression spring 961 coupled to the trash bin lid 901 at a fixed first anchor point 962 and to the pivoting latch 950 at a dynamic second anchor point 963. The first anchor point 962 and second anchor point 963 are configured to collinearly align with the center axis 953. When the second anchor point 963 is disposed between the center axis 953 and the first anchor point 962, the spring 961 is at its greatest elastic potential energy 964. A small movement in either direction from this unstable equilibrium causes the spring 961 to expand toward a lower-energy state, snapping the latch 950 into either the opening position 954 or the closing position 955. Alternatively, the bistable mechanism 960 may comprise physical friction components integrated at the center axis 953 to provide or supplement this stability.

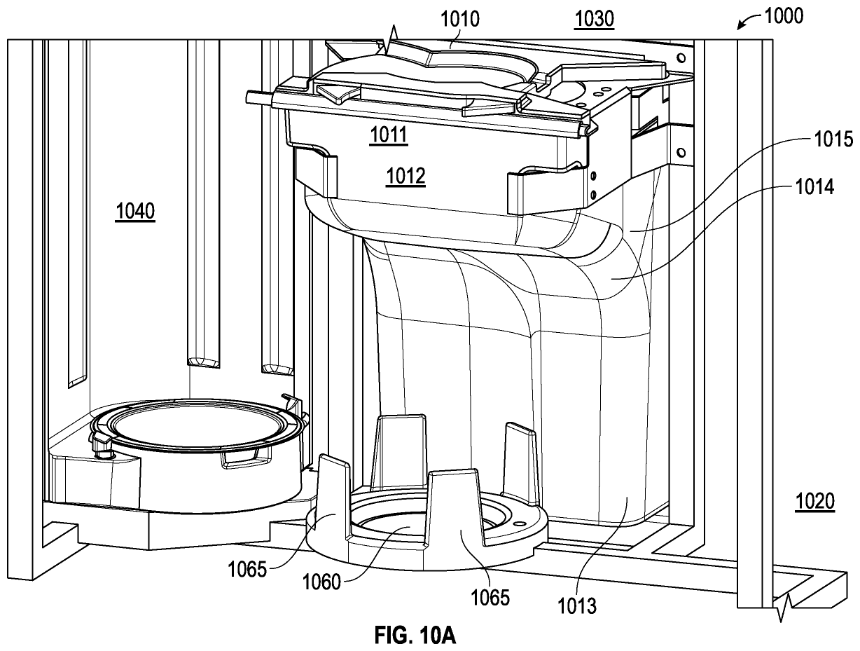

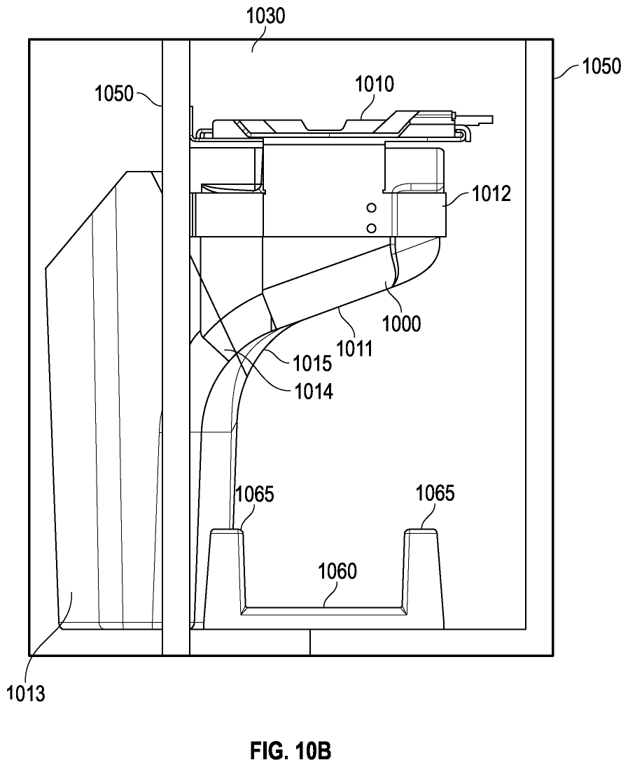

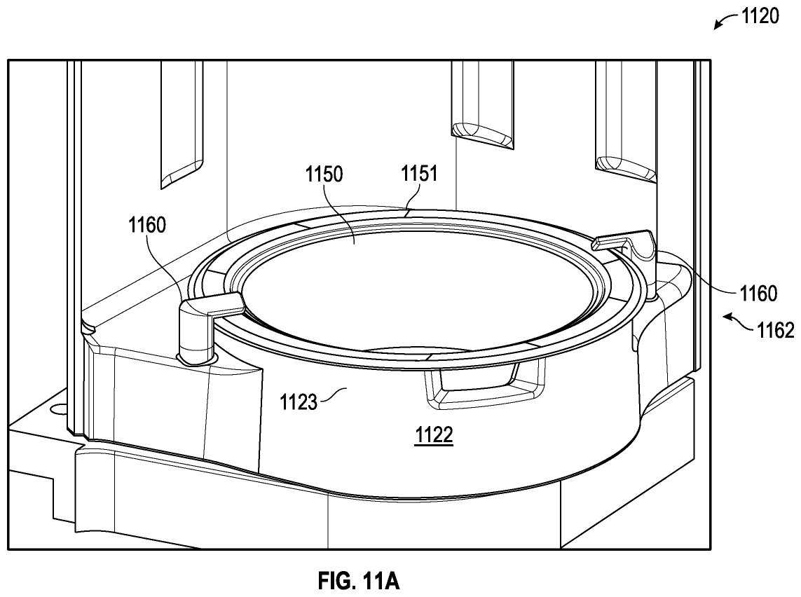

FIG. 10A-10B show the trash bin 1000 according to an alternative embodiment. The trash bin 1000 and a trash bin lid 1010 designed to manage waste and facilitate the reuse or disposal of components. The trash bin 1000 comprises a trash bin lid 1010 configured to slide open to provide access to an infeed zone 1012 of the trash bin 1000. The infeed zone 1012 is in fluid communication with a waste reservoir 1013 by an intermediate chute 1014, which is configured to transfer trash initially disposed into the infeed zone 1012 into the waste reservoir 1013.

The intermediate chute 1014 comprises an angle 1015 such that the infeed zone 1012 is disposed entirely within a housing 1050 of the machine, whereas at least a portion of the waste reservoir 1013 is disposed outside of the housing 1050. This spatial arrangement forms an overhang 1011, which is a descriptive term for the portion of the infeed zone 1012 that sits above a bowl stacking zone 1060. The overhang 1011 effectively separates a working area 1030 from the bowl stacking zone 1060. In this configuration, the infeed zone 1012 is disposed between the bowl stacking zone 1060 and the working area 1030. While the waste reservoir 1013 is shown physically protruding from the housing 1050, it is understood that in alternative embodiments, the waste reservoir 1013 may be disposed entirely internal to the housing 1050.

The bowl stacking zone 1060 is configured to receive and store used bowls retrieved by a gripper from a serving area 1040. The bowl stacking zone 1060 is disposed between the serving area 1040 and a supply area 1020, and is positioned under the working area 1030 and the infeed zone 1012 of the trash bin 1000. Additionally, the bowl stacking zone 1060 is disposed laterally adjacent to the waste reservoir 1013. To ensure the stability of the stored components, the bowl stacking zone 1060 comprises nesting ribs 1065 that are attached to the floor of the bowl stacking zone 1060 and extend upwards towards the infeed zone 1012 and the working area 1030. The nesting ribs 1065 are configured to retain and stabilize bowls stacked within the bowl stacking zone 1060. In certain embodiments, the trash bin 1000 is removable from the machine, allowing used bowls to be collected from the bowl stacking zone 1060 for washing or disposal by a user.

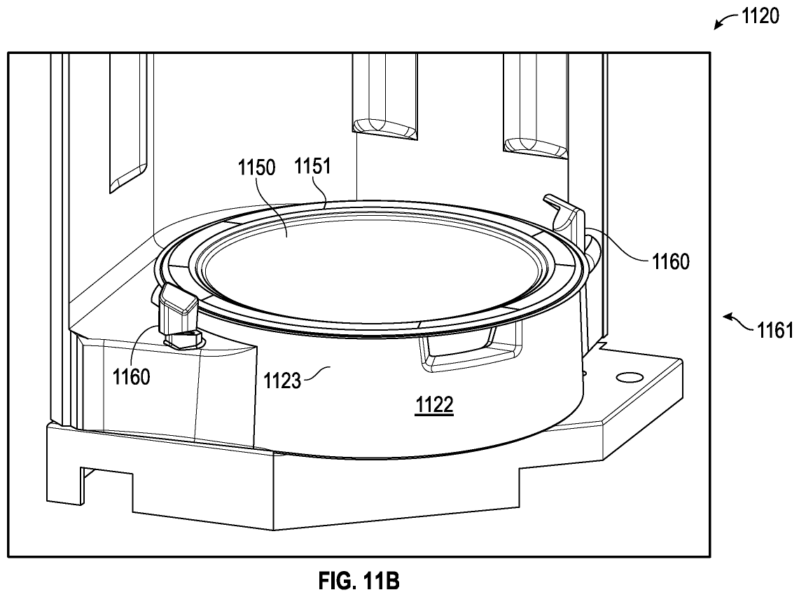

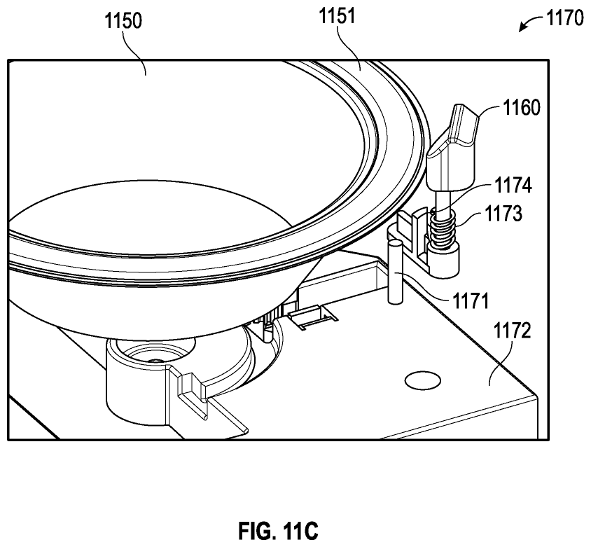

FIG. 11A-11C show the serving area according to an alternative embodiment. This serving area 1120 is configured to securely hold a bowl 1150 during consumption by a pet. The serving area 1120 comprises a bowl seat 1122 with retention walls 1123 configured to receive and hold the bowl 1150. To prevent displacement of the bowl 1150 by a pet, the serving area 1120 further comprises bowl retention latches 1160 configured to engage a bowl rim 1151. These bowl retention latches 1160 maintain the bowl 1150 in a locked position 1162 by securing the bowl rim 1151 against the retention walls 1123, thereby preventing the bowl 1150 from moving or spilling its contents.

The bowl retention latches 1160 are configured to rotate about a vertical axis and are mechanically linked with the rotation of a swivel door 130 (see FIG. 1). Specifically, the bowl retention latches 1160 comprise a latch driving mechanism 1170 that utilizes the rotational motion of the swivel door 130 to alternate the latches 1160 between an open position 1161 and the locked position 1162. This mechanical linkage ensures that additional motors or servos are not required to actuate the latches 1160. In some embodiments, the bowl retention latches 1160 rotate in the same direction as the swivel door 130.

The latch driving mechanism 1170 comprises a vertical pin 1171 attached to a serve base 1172, wherein the serve base 1172 is a non-moving part disposed below the swivel door 130. The latch driving mechanism 1170 further comprises a retention spring 1173 and a retention arm 1174 integrated with the bowl retention latches 1160. The retention arm 1174 is disposed below the retention spring 1173. Because the bowl retention latches 1160 and the integrated retention arm 1174 rotate with the swivel door 130, their state is determined by their position relative to the stationary vertical pin 1171.

When the swivel door 130 is in a closed state, the vertical pin 1171 physically contacts and pushes the retention arm 1174. This force overcomes the bias of the retention spring 1173, rotating the bowl retention latches 1160 away from the bowl rim 1151 and into the open position 1161. In this open position 1161, a gripper is permitted to retrieve the bowl 1150 from or place a bowl 1150 into the bowl seat 1122. Conversely, when the swivel door 130 rotates toward an open state, the retention arm 1174 moves away from the stationary vertical pin 1171. As the physical obstruction of the pin 1171 is removed, the retention spring 1173 drives the bowl retention latches 1160 to rotate toward the bowl 1150, thereby securing the bowl rim 1151 in the locked position 1162. Consequently, the bowl retention latches 1160 are automatically in the locked position 1162 whenever the swivel door 130 is opened for pet access.

Although the opener assembly presented here works with the pull-ring type of cans, the automatic can food feeder in this disclosure is capable of working with other types of cans too by modifying or redesigning the can opener assembly, while other methods and aspects of this disclosure can be still utilized.

What is claimed is:

1. An automatic can feeder system, comprising
a housing comprising a trash area disposed between a supply area and a serving area, and a working area disposed above the trash area;
a trash bin located in the trash area, the trash bin comprising a trash bin lid configured to horizontally translate along a track between a closed state and an opened state;
one or more vertical posts configured to move horizontally within the housing from the supply area to the serving area; and
an engagement member rotatably coupled to the trash bin lid, the engagement member being configured to engage with and receive a horizontal force from the one or more vertical posts;
wherein horizontal translation of the one or more vertical posts results in the trash bin lid translating horizontally along the tracks.

2. The system of claim 1, wherein the one or more vertical posts are configured to move the trash bin lid from the opened state to the closed state.

3. The system of claim 2, wherein the one or more vertical posts are configured to move the trash bin lid from the closed state to the opened state.

4. The system of claim 1, wherein the engagement member is rotatably configurable in a plurality of positions, wherein a first position of the plurality of positions comprises engagement with the one or more vertical posts, and a second position of the plurality of positions comprises disengagement from the one or more vertical posts.

5. The system of claim 1, wherein the trash bin lid is configured to translate into the serving the area.

6. The system of claim 1, the engagement member further comprising a pivoting latch rotatably coupled to the trash bin lid about a center axis.

7. The system of claim 6, the pivoting latch further comprising a first latch arm and a second latch arm, wherein the first latch arm and the second latch arm are each configured to extend outward from an outer edge of the trash bin lid.

8. The system of claim 7, wherein the one or more vertical posts is configured to engage with one of the first latch arm or the second latch arm to move the trash bin lid into one of the opened state or the closed state.

9. The system of claim 8, wherein the pivoting latch is configured to rotate between an opening position and a closing position, wherein while in the opening position the pivoting latch is configured to engage with the one or more vertical posts to move the trash bin lid from the closed state into the opened state, and wherein while in the closing position the pivoting latch is configured to engage with the one or more vertical posts to move the trash bin from the opened state to the closed state

10. The system of claim 9, the pivoting latch further comprising a bistable mechanism to provide stability to the pivoting latch in both the opening position and the closing position.

11. The system of claim 10, wherein the bistable mechanism comprises a compression spring coupled to the trash bin lid at a fixed first anchor point, and to the pivoting latch at a dynamic second anchor point.

12. The system of claim 11, wherein the first anchor point and the second anchor point are configured to collinearly align with the center axis of the pivoting latch such that the compression spring reaches a state of greatest elastic potential energy when the second anchor point is positioned between the center axis and the first anchor point.

13. The system of claim 12, wherein the bistable mechanism is configured to move the pivoting latch towards one of the opening position or the closing position in response to a threshold force applied by the one or more vertical posts against one of the first latch arm or the second latch arm.

14. The system of claim 9, wherein the opening position of the pivoting latch comprises the first latch arm extended further outward from the outer edge than the second latch arm.

15. The system of claim 14 wherein the closing position comprises the second latch arm extended further outward from the outer edge than the first latch arm.

16. The system of claim 9, wherein the pivoting latch is in the opening position when the trash bin lid is fully in the closed state.

17. The system of claim 16, wherein the pivoting latch is in the closing position when the trash bin is fully in the opened state.

18. An automatic can feeder system, comprising
a housing comprising a trash area disposed between a supply area and a serving area, and a working area disposed above the trash area;
a trash bin located in the trash area, the trash bin comprising a trash bin lid configured to horizontally translate along a track between a closed state and an opened state;
one or more vertical posts configured to move horizontally within the housing from the supply area to the serving area; and
an engagement member comprising a pivoting latch rotatably coupled to the trash bin lid about a center axis, the engagement member being configured to engage with and receive a horizontal force from the one or more vertical posts, wherein the engagement member is rotatably configurable in a plurality of positions, wherein a first position of the plurality of positions comprises engagement with the one or more vertical posts, and a second position of the plurality of positions comprises disengagement from the one or more vertical posts;
wherein horizontal translation of the one or more vertical posts results in the trash bin lid translating horizontally along the tracks, and further wherein the one or more vertical posts are configured to move the trash bin lid from the opened state to the closed state and from the closed state to the opened state.

19. The system of claim 18, the pivoting latch further comprising a first latch arm and a second latch arm, wherein the first latch arm and the second latch arm are each configured to extend outward from an outer edge of the trash bin lid.

20. The system of claim 19, wherein the one or more vertical posts is configured to engage with one of the first latch arm or the second latch arm to move the trash bin lid into one of the opened state or the closed state.
